(19) United States
(12) Patent Application Publication
(10) Pub. No.: US 2017/0362007 A1
(43) Pub. Date: Dec. 21, 2017

(54) Total Drain Container Device System

(71) Applicant: Richard Andrew Kirchmeyer, Plano, TX (US)

(72) Inventor: Richard Andrew Kirchmeyer, Plano, TX (US)

(21) Appl. No.: 15/182,968

(22) Filed: Jun. 15, 2016

(51) Int. Cl. B65D 77/24; B65D 77/06; B67D 3/00

(52) U.S. Cl. CPC B65D 77/24; B67D 3/0067; B65D 77/068; B67D 3/0029

(57) ABSTRACT

A total liquid drain container device comprising a wedge shaped insert used in conjunction with any bag-in-box type containers. This invention relates preferably to box wine containers and is a wedged shaped insert that is approximately one-quarter to one-half inch thicker on one side whereas the opposite or thinner side contains a cutout design to allow room for the bag-in-box drain spout. The wedge shape of the insert allows the contents inside the container bag to flow in the direction of the drain spout. The wedge shaped insert raises the bag to a position where the bottom of the bag is now aligned with the drain spout thus eliminating the need for tilting. This invention resolves two design issues of conventional bag-in-box containers; the need to tilt the container and the issue with not being able to drain the entire contents.

### FIELD OF THE INVENTION

This invention relates to the field of liquid bag draining devices. This invention more directly relates to the classification of flexible containers disposed within polygonal containers formed by folding a carton blank.

### BACKGROUND OF THE INVENTION

Traditionally wine is thought of as being served from a bottle but over the last 50 years there has been a gradual acceptance in serving wine and other consumables from a plastic bag within a box (“bag-in-box”). One of the largest sellers of the bag-in-box containers is with the wine industry. Wine makers/manufactures, wholesalers, and retailers have successfully marketed the bag-in-box or wine box idea for over 50 years. Wine manufactures prefer the bag-in-box containers because they provide the consumer a less expensive alternative to glass bottles. Moreover, the box wines are transported more efficiently since they can be stacked closer than bottles cutting down on the transportation costs and eliminating the potential for breaking glass bottles. Further, box wines are not as susceptible to oxidation after opening since the bag inside collapses around the wine keeping air out while maintaining freshness. However an important drawback to bag-in-box or wine box containers is that the liquid is never totally dispensed wasting precious wine and other resources which are needlessly expended on a portion of wine that will never be consumed.

The present invention will prevent wasted wine that will never be consumed and additionally is more environmentally resource conscious. The traditional bag-in-box container has not been redesigned since its first implementation over 50 years ago. The simple idea of putting a bag in a cardboard box has limitations and design issues being that it is difficult to totally drain all the contents. This invention provides the consumers with a better value in their wine purchase.

### Description of Prior Art

Major problems facing current bag-in-box devices is that of the remaining unconsumed volume of the fluid in the bag/bladder pack within the bag-in-box, which holds the fluid. The current invention solves this problem by assuring total dispensing of the liquid within the bag/bladder pack within the bag-in-box. None of the current boxed wine systems which the inventor has researched totally dispenses all the liquid/wine out of the current bag-in-box designs. The inventor continually noticed, while separating the bag/bladder pack from the box, for recycling purposes, that there was a noticeable volume of wine left inside the wine bag. While looking for a way to solve this problem the inventor came up with the unique idea of elevating the bag/bladder pack while keeping the spout in its original position. The uniqueness of the wedge platform involves a cutout at the front of the wedge at the lowest end to allow room for the position of the drain spout. After several mockups and prototypes the inventor developed this invention device which solves these issues. Combining this invention with the traditional bag-in-box or wine box containers; the invention allows the bag-in-box to totally drain all the contents without tilting the container. This new invention now allows the consumer who pays for 5 liters of consumable to be able to enjoy all 5 liters consumable.

For at least the foregoing reasons, there is a need for the present invention that dispenses the total volume of fluid within the bag-in-box designs. The current invention solves this problem by assuring total dispensing of the liquid within the bag-in-box.

### SUMMARY

The present invention is directed to a total liquid drain container device system comprising a bladder pack; a box member containing the bladder pack; a sloping wedge shaped platform insert which is inserted underneath the said bladder pack; the said sloping wedge shaped platform insert to be sufficiently strong to support the weight of the said bladder pack full of liquid; the said a sloping wedge shaped platform insert to have a wedge cutout at the lowest end of the said sloping wedge shaped platform insert; a drain spout; the said wedge cutout sufficient in width to allow the said drain spout to be in a position lower than at least ¼ inch lower than the lowest sloped edge of the sloping wedge bag support platform insert to allow full drainage of the fluid contents of the box member without the need to tip or tilt the said box member containing the said bladder pack to dispense the totality of the liquid within the bladder pack; the said drain spout to be attached to and sealed within the bladder pack; a circular box cutout within the box member sufficiently sized for insertion of the said drain spout; the said drain spout to be positioned within the said circular box cutout allowing the said drain spout to sit below the top of the said sloping wedge shaped platform insert allowing total drainage without the need for tilting the box.

The apparatus disclosed herein allows for the totality of all liquid within bag-in-box devices without tilting the box devices itself. Being that expanded polystyrene or

Styrofoam ^{TM} may be the preferred embodiment of the wedge material itself will also add an insulating quality and protect the sensitive contents of the bag from temperature differences that may result from the box sitting on too warm or too cold of surfaces. The inventor also noticed that many bag-in-box containers have ruptures in the cardboard box members that are likely caused by mishandling or dropping of the containers. The solid wedge platform located at the bottom of the box will add some cushion value while adding strength thus improving the structural integrity of the box.

A distinct feature of the wedge platform is the cutout at the front of the platform. This allows for the bag/bladder pack inside the container to sit higher while the spout maintains its location on the box with the cutout allowing the necessary room for the contents to flow to the spout. This solves the issue of conventional bag-in-box containers that are unable to totally drain all the contents. The apparatus, being a expanded polystyrene or Styrofoam™ wedge platform with a unique cutout design, resolves many issues found in the current bag-in-box containers improving value to the consumer and environment.

### Factors and Aspects of the Invention

First, the inventor is not aware of any liquid dispensing container devices that no totally dispense liquid in a bag without titling the liquid dispensing container.

Second, embodiments of this invention include total drain container device systems capable of holding, storing, and dispensing wine and other consumable liquids.

Third, embodiments of the invention include total drain container device systems capable of holding, storing, and dispensing both consumable and non-consumable liquids.

For at least the foregoing reasons, there is a need for the total drain container device systems capable of holding, storing, and dispensing wine and other consumable liquids without the need to tilt the container device.

The foregoing and other objects, features, and advantages of the invention will become more apparent from the following detailed description, which proceeds with reference to the accompanying figures wherein the scale depicted is approximate.

### BRIEF DESCRIPTION OF THE DRAWING FIGURES

FIG. 1 is a side plain view of a partial section of one embodiment in a typical bag-in-box container;

FIG. 2 is a side plain view of a partial section of one embodiment according to the present invention with the wedge platform installed.

FIG. 3 is a front and right side view illustrating a box wine container with spout and an exploded view demonstrating the liquid flow and how the sloping wedge platform cutout enables the spout opening to be positioned lower than the top of the sloped wedge platform allowing total drainage without the need for tilting the box;

FIG. 4 is a front and right side view with arrows demonstrating the fluid flow and how the sloping wedge platform cutout enables the fluid to flow down and out through the spout allowing total drainage without the need for tilting the box;

FIG. 5 is a front and right side view of the wedge platform inside an outline of a container demonstrating the cutout at the front of the lowest sloped edge of the wedge platform to allow the drain spout to sit below the top of the wedge platform;

FIG. 6 is a front and right side view that illustrates the wedge platform inside an outline of a container showing the location of drain spout within the cutout allowing the drain spout to sit below the top of the wedge platform allowing total drainage without the need for tilting the box;

FIG. 7 is a front and left side view of the wedge platform inside an outline of a container demonstrating the cutout at the front of the lowest sloped edge of the wedge platform to allow the drain spout to sit below the top of the wedge platform;

FIG. 8 is a front and left side view that illustrates the wedge platform inside an outline of a container showing the location of drain spout within the cut out allowing the drain spout to sit below the top of the wedge platform allowing total drainage without the need for tilting the box;

FIG. 9 is a front and left side view of the wedge platform;

FIG. 10 is a front and right side view of the wedge platform;

FIG. 11 is a top view of the wedge platform showing the position of the container drain spout;

FIG. 12 is a right side view of the wedge platform illustrating how the cutout allows the drain spout to sit below the top of the wedge platform;

FIG. 13 is a bottom view of the wedge platform showing the position of the container drain spout;

FIG. 14 is a left side view of the wedge platform illustrating how the cutout allows the drain spout to sit below the top of the wedge platform.

### REFERENCE LISTING OF THE NUMBERED ELEMENTS

100 bladder pack
120 box member
130 drain spout
140 sloping wedge shaped platform insert
150 wedge cutout
160 circular box cutout
170 box member top
171 box member bottom

### DEFINITIONS

In the following description, the term “sloping wedge shaped platform insert” as used herein, means a wedge made of Expanded Polystyrene or Styrofoam™ or other material sufficiently strong to support the weight of a bag capable of holding liquid.

In the following description, the term “bladder pack” as used herein, means a liquid container bag or a bag capable of containing liquid.

In the following description, the term “box member” as used herein, means polygonal container capable of holding and supporting the bladder pack, the liquid within the bladder pack, the wedge shaped insert, drain spout.

As used herein, “fasteners” means any customary means to fasten one object to another, including threaded fasteners, non-threaded fasteners, staples, tape, adhesives, welding, or other means as will be appreciated by those having skill in the art and benefit of this disclosure whether for permanent or semi-permanent use. Unless otherwise explained, any technical terms used herein have the same meaning as commonly understood by one of ordinary skill in the art to which this disclosure belongs. The singular terms “a”, “an”, and “the” include plural referents unless the context clearly indicates otherwise. Similarly, the word “or” is intended to include “and” unless the context clearly indicates otherwise. Although methods and materials similar or equivalent to those described herein can be used in the practice or testing of this disclosure, suitable methods and materials are described below. The term “comprises” means “includes.” All publications, patent applications, patents, and other references mentioned herein are incorporated by reference in their entirety for all purposes. In case of conflict, the present specification, including explanations of terms, will control. In addition, the materials, methods, and examples are illustrative only and not intended to be limiting.

### REFERENCE TO FIGURES

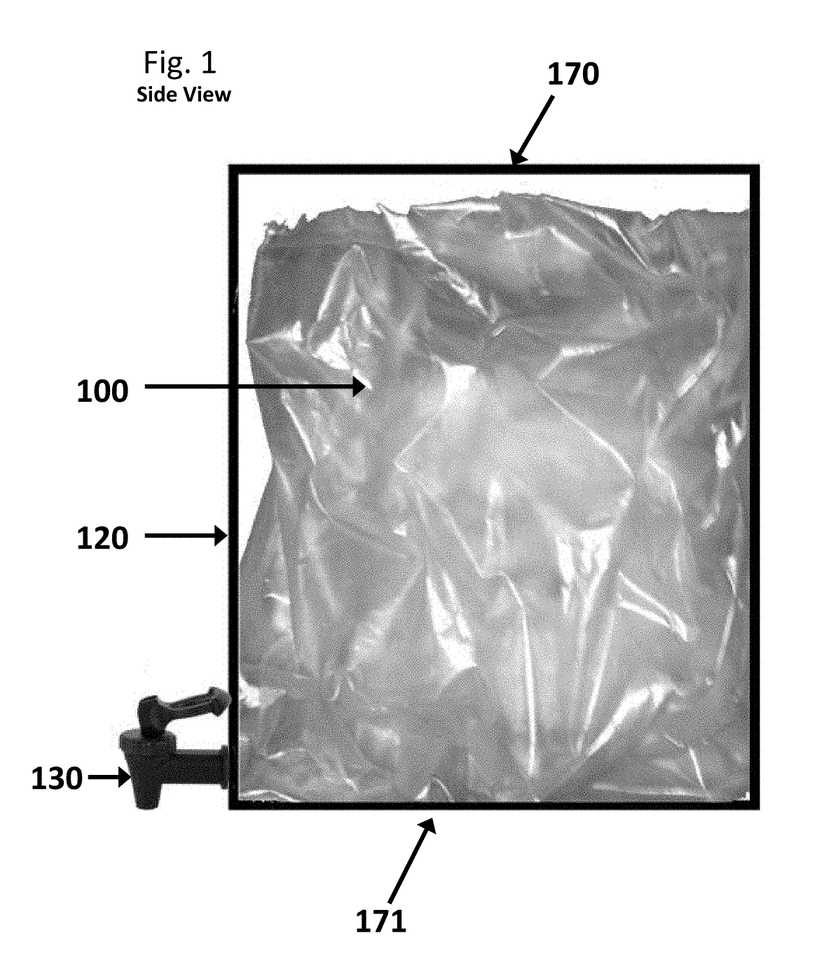

Referring to the FIG. 1 illustrates the typical bag-in-box container.

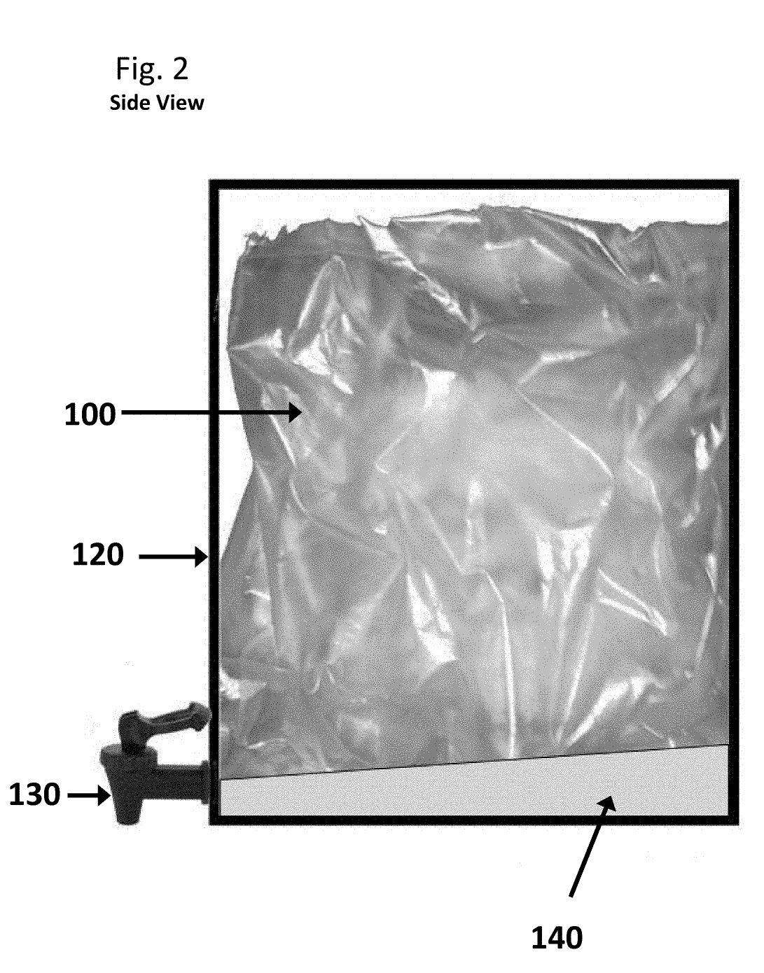

Referring to the FIG. 2 the sloping wedge shaped insert 140, is inserted in the container bag member-box 120 and position so that the lowest end with wedge cutout 150 is located at the drain spout 130, the bottom of the bladder pack 100, is then aligned with the opening in the drain spout 130,

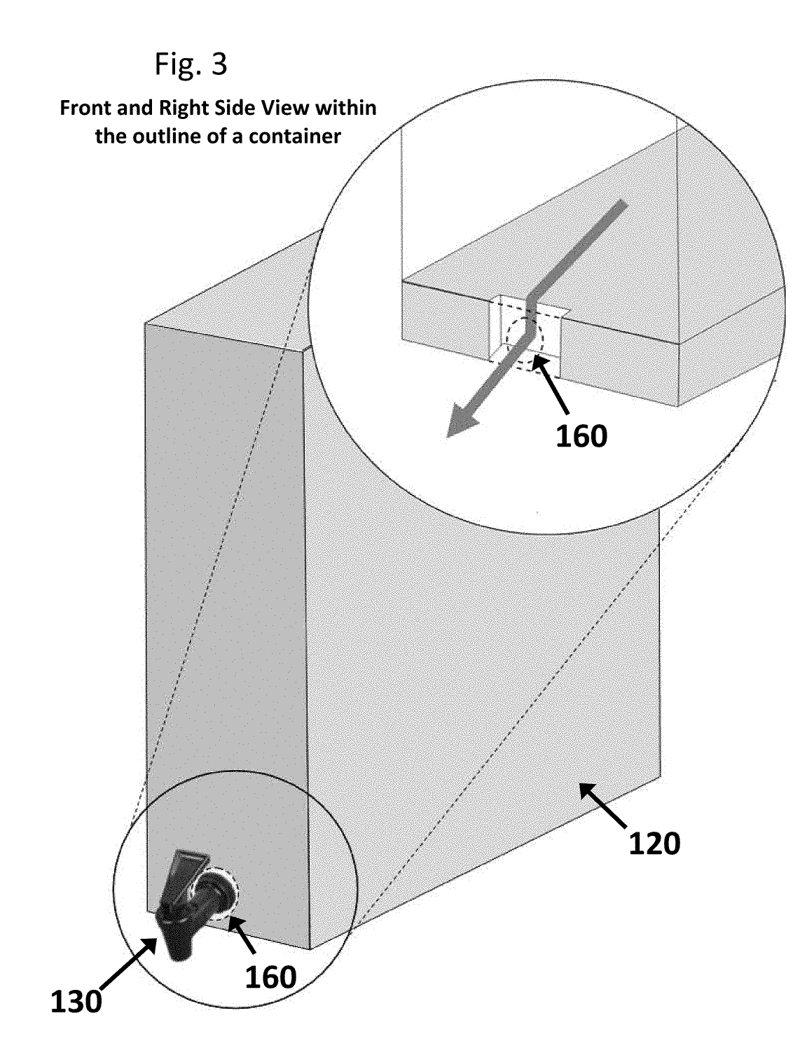

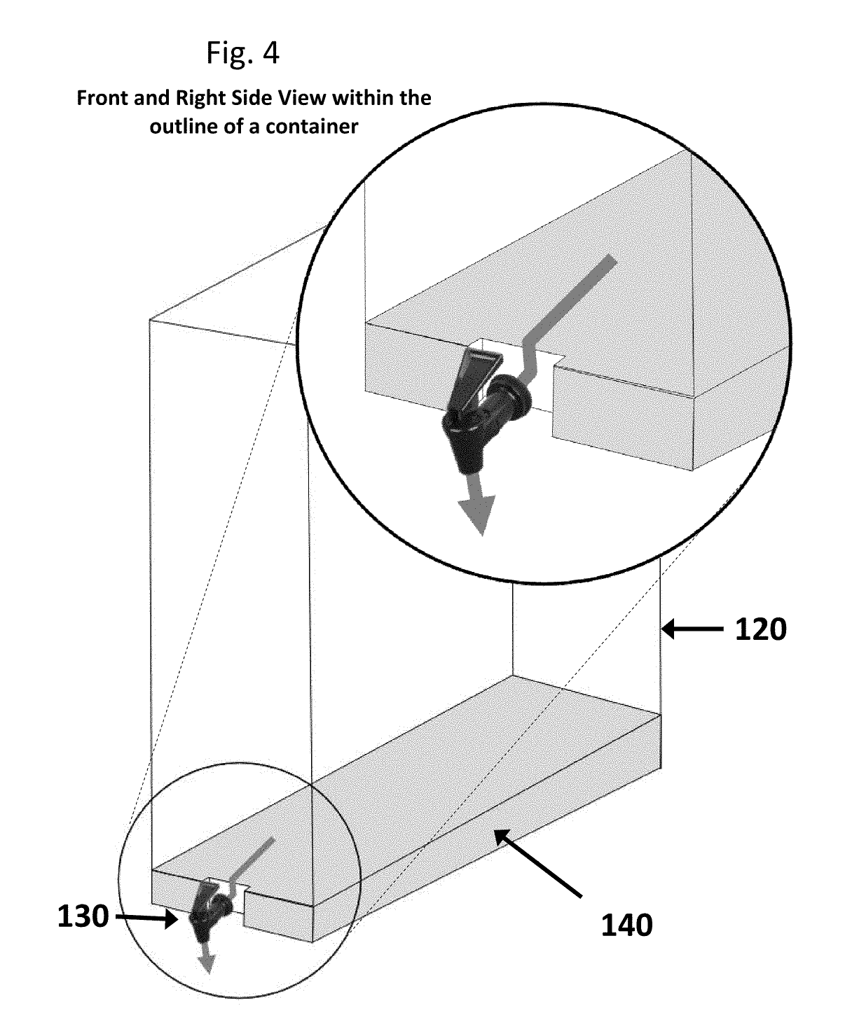

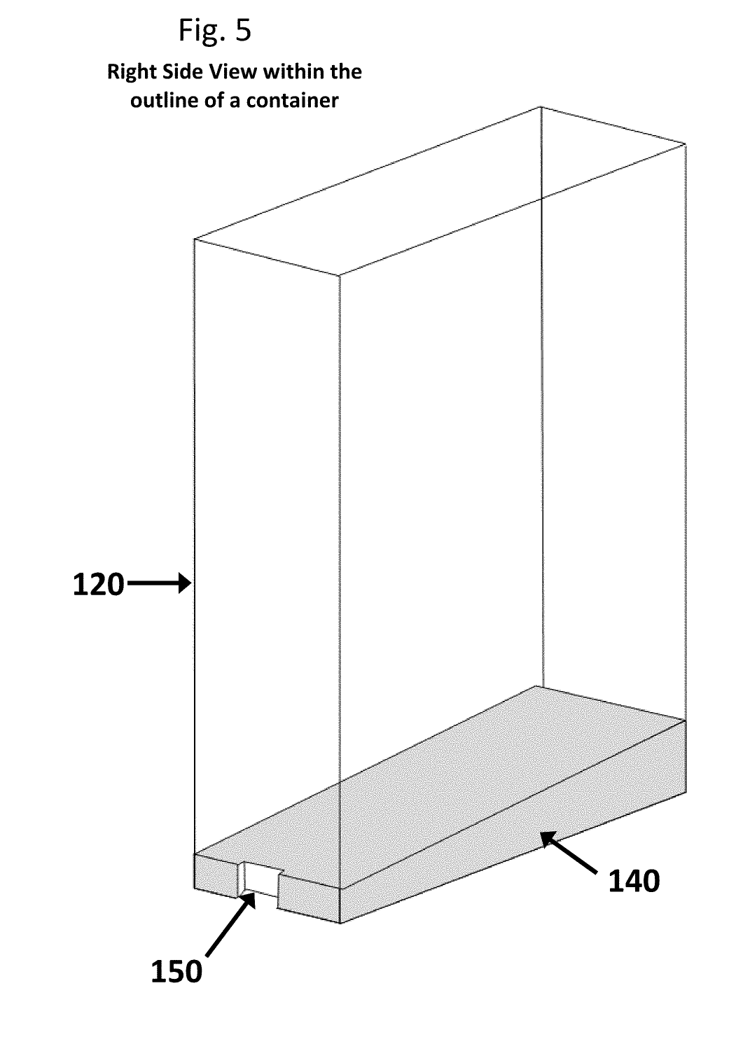

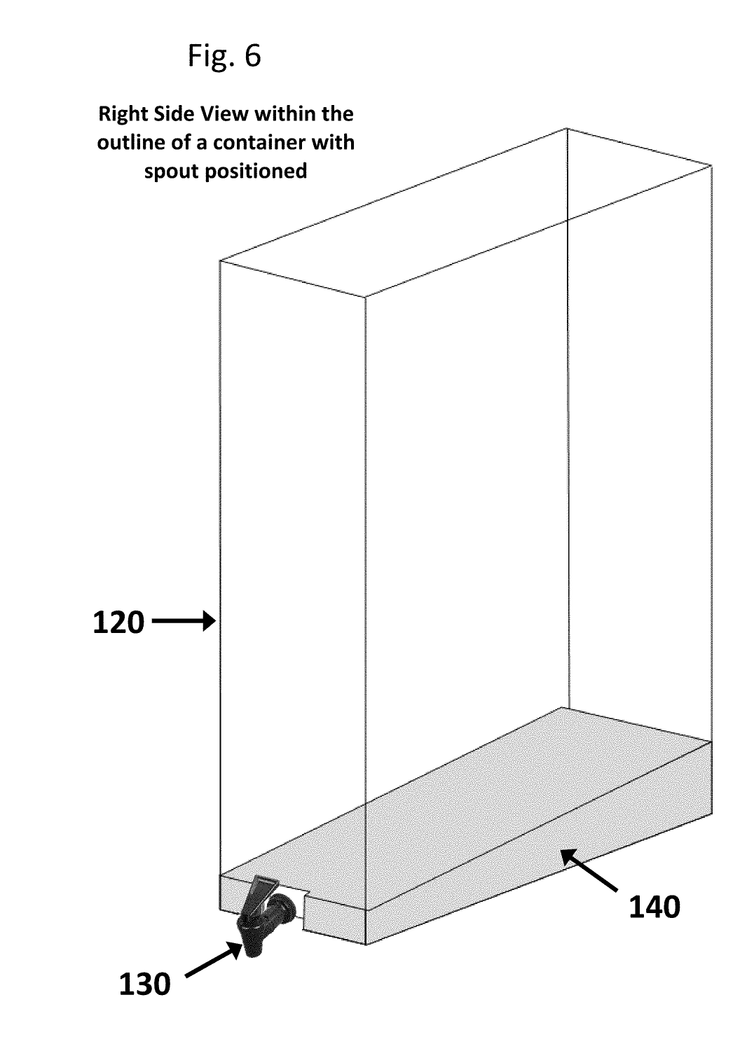

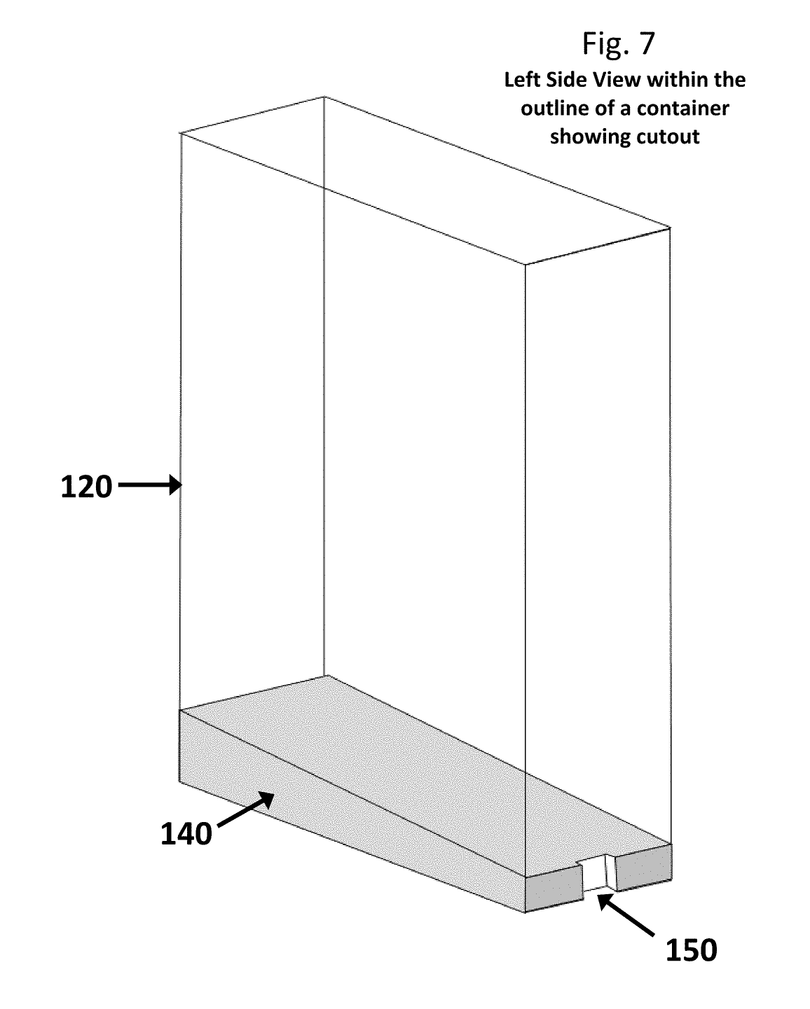

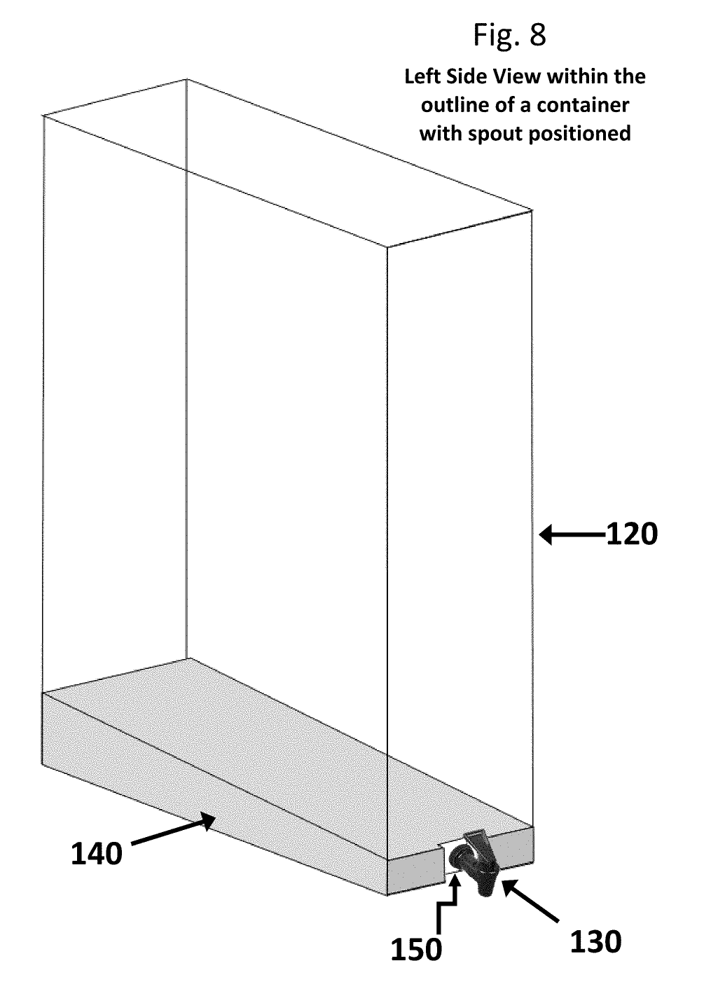

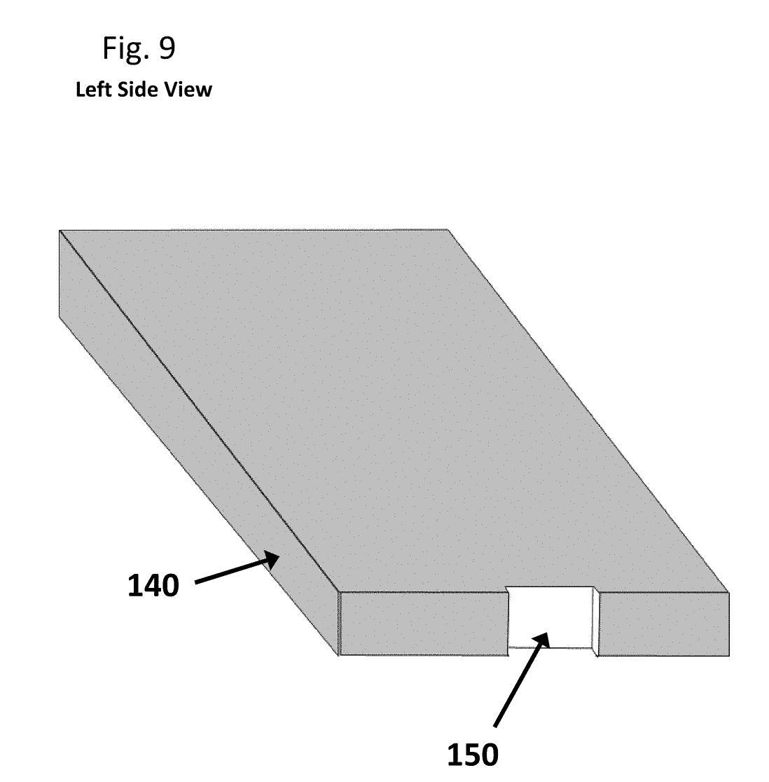

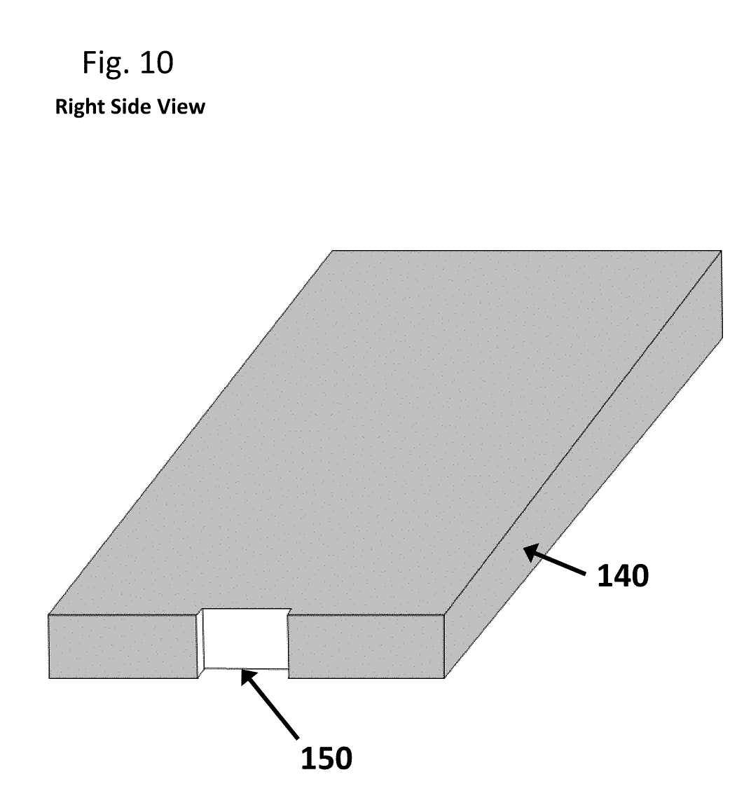

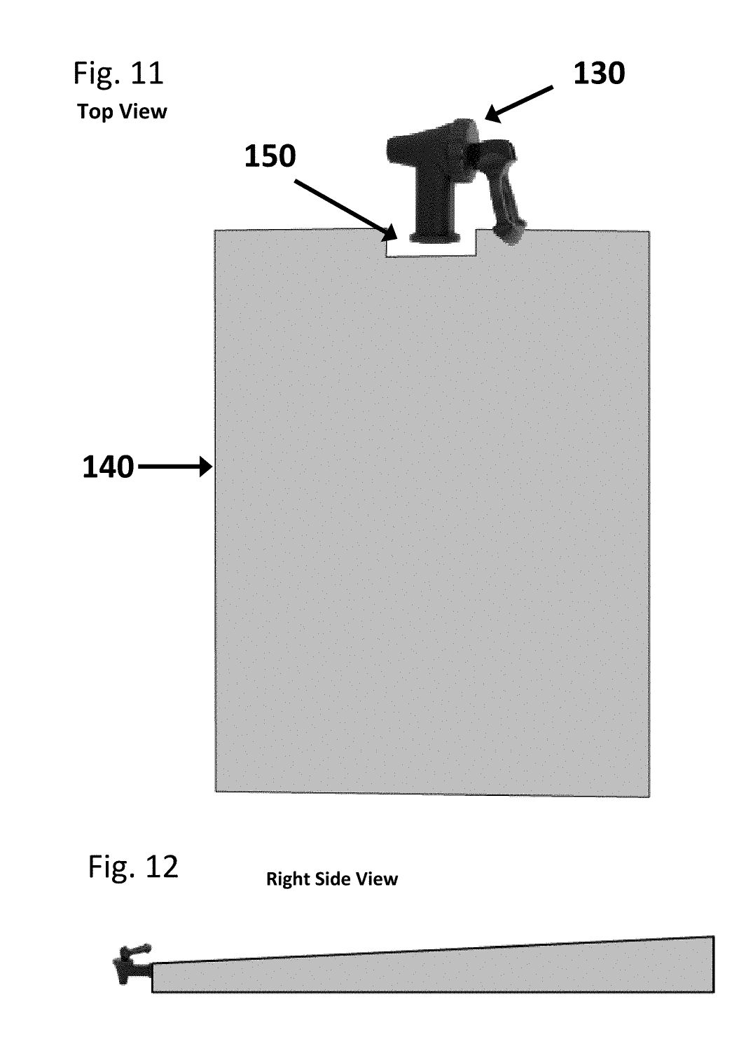

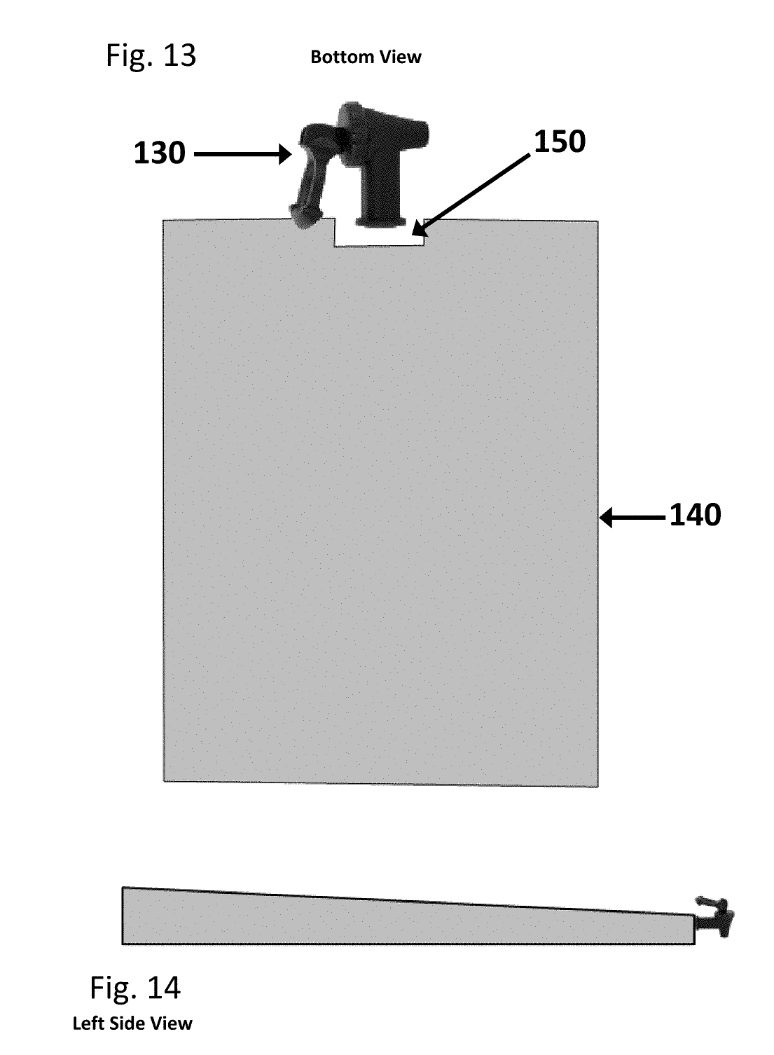

Referring generally to FIGS. 1-14, embodiments according to the present invention for a total liquid drain container device comprising a sloping wedge shaped platform insert 140, that is positioned inside the box member 120, so that the angled and sloping surface of the sloping wedge shaped platform insert 140 is at the top and the level side of the sloping wedge shaped platform insert 140 is at the box member bottom 171, of the box member container 120, the wedge cutout 150, of the sloping wedge shaped platform insert 140 is positioned at the circular box cutout 160.

The sloping wedge shaped platform insert 140 will have a wedge cutout 150 of sufficient size to accommodate the different size and shapes of different drain spout 130 configurations, size and it's attachment to the bladder pack 100. Said bladder pack 100 will then be inserted into the box member 120 with the bladder pack 100 attached drain spout 130 will be at the same side as the circular box cutout 160, the bladder pack bag 100 will then be positioned so the attached drain spout 130 can protrude through the circular box cutout 160.

Once positioned in the box member 120 the sloping wedge shaped platform insert 140 is now elevating the bladder pack 100, to the same level or higher than the drain spout 130, the angel or slope at the top of the sloping wedge shaped platform. Insert 140 will enable the fluid contents of the bladder pack 100 to flow towards the drain spout 130 without the aid of tilting the box member 120, and thus drain the totality of the fluid contents of the bladder pack 100.

It should be understood that the drawings and detailed description herein are to be regarded in an illustrative rather than a restrictive manner, and are not intended to be limiting to the particular forms and examples disclosed. Accordingly, it is intended that this disclosure encompass any further modifications, changes, rearrangements, substitutions, alternatives, design choices, and embodiments as would be appreciated by those of ordinary skill in the art having benefit of this disclosure, and falling within the scope of the following claims.

What is claimed is:

1. A total drain container device system comprising:
a bladder pack; a box member containing the bladder pack;
a sloping wedge shaped platform insert which is inserted underneath the said bladder pack; the said sloping wedge shaped platform insert to be sufficiently strong to support the weight of the said bladder pack full of liquid; the said a sloping wedge shaped platform insert to have a wedge cutout at the lowest end of the said sloping wedge shaped platform insert; a drain spout; the said wedge cutout sufficient in width to allow the said drain spout to be in a position lower than at least ¼ inch lower than the lowest sloped edge of the sloping wedge bag support platform insert to allow full drainage of the fluid contents of the box member without the need to tip or tilt the said box member containing the said bladder pack to dispense the totality of the liquid within the bladder pack; the said drain spout to be attached to and sealed within the bladder pack; a circular box cutout within the box member sufficiently sized for insertion of the said drain spout; the said drain spout to be positioned within the said circular box cutout allowing the said drain spout to sit below the top of the said sloping wedge shaped platform insert allowing total drainage without the need for tilting the box.

2. An total drain container device system comprising as in claim 1 where in the said sloping wedge shaped platform insert is made out of expanded polystyrene, Styrofoam™, or other material.

3. An total drain container device system comprising as in claim 1 where in the said sloping wedge shaped platform insert is made out of a thick piece of sloping cardboard.
